(19) United States
(12) Patent Application Publication
(10) Pub. No.: US 2002/0059140 A1
(43) Pub. Date: May 16, 2002

(54) Methods and system for communications service revenue collection

(76) Inventors: Christer Fahraeus, Lund (SE); Petter Ericson, Malmo (SE)

Correspondence Address: BIRCH STEWART KOLASCH & BIRCH, PO BOX 747, FALLS CHURCH, VA, 22040-0747, US

(21) Appl. No.: 09/987,151

(22) Filed: Nov. 13, 2001

Related U.S. Application Data
(60) Provisional application No. 60/281,786, filed on Apr. 6, 2001.
(60) Provisional application No. 60/277,285, filed on Mar. 21, 2001.
(60) Provisional application No. 60/261,122, filed on Jan. 12, 2001.

(30) Foreign Application Priority Data
Nov. 13, 2000 (SE) 0004156-6
Apr. 6, 2001 (SE) 0101240-0

(51) Int. Cl. G06F 17/60

(52) U.S. Cl. 705/40

(57) ABSTRACT

Methods and systems for communications service revenue collection may include a mapping lookup service. The mapping lookup service is configured to retrieve mapping information corresponding to a position of a digital pen on digital paper in response to a request for the mapping information from the digital pen. A service provider or network operator who offers a service corresponding to the position of the digital pen on digital paper may be billed by the mapping lookup service for retrieving the mapping information.

### CROSS-REFERENCE TO RELATED APPLICATIONS

This application claims priority under 35 U.S.C. § 119 of: U.S. Provisional Application No. 60/281,786, entitled Methods and System for Communications Service Revenue Collection, filed Apr. 6, 2001; U.S. Provisional Application No. 60/277,285, entitled Communications Services Methods and Systems, filed Mar. 21, 2001; and U.S. Provisional Application No. 60/261,122, entitled Method, System and Product for Information Management, filed Jan. 12, 2001. The disclosures of the above-identified Provisional Applications are expressly incorporated herein by reference in their entirety. This application also claims priority under 35 U.S.C. § 119 of: Swedish Patent Application No. 0004156-6, filed Nov. 13, 2000; and Swedish Patent Application No. 0101240-0, filed Apr. 6, 2001.

### FIELD OF THE INVENTION

The present invention relates generally to data processing systems and, more particularly, to systems and methods for collecting revenue for services in a communications system.

### BACKGROUND MATERIAL AND INFORMATION

Network enabled computers and other communications devices allow individuals to electronically communicate and to electronically conduct business transactions. For example, e-mail is often used for message transmission, and Internet web sites permit procurement of information, goods, and services over a network.

The manner in which a network may be accessed can vary depending on the type of hardware being used. For example, access to a mobile phone network often occurs using keys on the mobile phone, or in some instances through voice commands. Network access through a PDA may be achieved using a stylus on a sensing surface, and network access through a personal computer or laptop is often achieved through a keyboard or mouse.

Some network based communications and transactions might be impeded by input devices that users find cumbersome or awkward. While individuals are often very comfortable conveying information using pen and paper, and secondarily using keyboards and mouses, as communications hardware becomes smaller, input devices become more difficult to use. This can impede use of the technology.

In addition, network-based financial transactions may be impeded by awkward or cumbersome payment procedures and schemes. If methods of payment are unduly burdensome or even somewhat cumbersome, wide spread adoption of the technology may be adversely affected.

### SUMMARY OF A FEW ASPECTS OF THE INVENTION

A method for collecting payments in a communications system may include receiving a request, via a provider of communications services, to provide a product to a user. The request may be generated in response to the user detecting information using a pen-like device that generates a signal reflective of the request. Information may then be transmitted in response to the received request. In addition, a request for payment may then be made to the provider of communications services.

The product may include an information look-up provided by a look-up service, and the request for payment may seek reimbursement for a look-up fee by the lookup service. The request for payment may include a single request for reimbursement for multiple information lookups. The user might be indirectly billed through the communications services provider. Billing may be performed on a transactional basis, or might occur in batches.

The product might also be goods or services ordered by the user from a vendor. In this case, the provider of communications services might reimburse the vendor for a purchase by the user, and thereafter bill the user for the services, perhaps along with an added transaction fee. The vendor might also pay a transaction fee or percentage to the communications services provider for mediating the transaction. The provider of communications services may then bill the user for the user's purchase from the vendor in a single billing statement which also invoices communications services.

In another exemplary sense, the invention may include a method for collecting payments in an communications system where a request is sent to a lookup service to provide an information lookup to a user. The request may be generated in response to the user detecting information using a pen-like device that generates a signal reflective of the request. Information may then be transmitted from the look-up service to the user, and an entity other than the user may then be billed a fee for the information lookup.

As a further example, the invention may include a method for collecting payments in a communications system where a request for mapping information corresponding to a position of a digital pen on digital paper, is sent to a mapping lookup service. The position of the pen on paper may correspond to a service offered by a network operator. Mapping information may then be retrieved and sent to the digital pen, and a payment collected from the network operator for retrieving the mapping information.

The above information is exemplary of but a few aspects of the invention, and is not intended to reflect the full scope and spirit of the invention.

### BRIEF DESCRIPTION OF THE DRAWINGS

The accompanying drawings are incorporated in and constitute a part of this specification and, together with the description, explain the features and principles of the invention. In the drawings:

FIG. 1A is a diagram of an exemplary network environment in which features and aspects of the present invention may be implemented;

FIG. 1B depicts a lookup table for use by a mapping lookup service represented in FIG. 1A;

FIG. 2 is an exemplary flowchart of a method for a first billing arrangement in a manner consistent with the present invention;

FIG. 3 is an exemplary diagram of an interaction between an individual end user, network operator, and mapping lookup service, consistent with the billing arrangement described in FIG. 2;

FIG. 4 is an exemplary flowchart of a method for a second billing arrangement in a manner consistent with the present invention;

FIG. 5 is an exemplary diagram of an interaction between an individual end user, network operator, service provider, and mapping lookup service, consistent with the billing arrangement described in FIG. 4;

FIG. 6 is an exemplary flowchart of a method for a third billing arrangement in a manner consistent with the present invention;

FIG. 7 is an exemplary diagram of an interaction between an individual end user, network operator, service provider, and mapping lookup service, consistent with the billing arrangement described in FIG. 6;

FIG. 8 is an exemplary flowchart of a method for a fourth billing arrangement in a manner consistent with the present invention; and

FIG. 9 is an exemplary diagram of an interaction between an individual end user, network operator, service provider, payment provider, and mapping lookup service, consistent with the billing arrangement described in FIG. 8.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the principles of the invention enable communications service revenue collection. A mapping lookup service may retrieve mapping information corresponding to a position of a digital pen on digital paper in response to a request for the mapping information from the digital pen. Alternatively, an electronic pen-like device may be used to read or otherwise generate an instruction and transmit that instruction over a network.

A service provider or network operator may offer a service that correlates either the position of the digital pen on digital paper to a requested action, or to otherwise convey the instruction and provides a requested action in response. The service provider or network operator may then be billed, for example, by the mapping lookup service for retrieving the mapping information.

In a first billing arrangement, the network operator may offer a service corresponding to the position of the digital pen and may bill an end user for that service. In a second billing arrangement, the network operator may bill the service provider for access to a communications network and no cost is passed on to the end user, according to an agreement between the service provider and the network operator, when the service provider is offering the service to an end user. In a third billing arrangement, the network operator may bill the service provider and the end user for access to a communications network. In a fourth billing arrangement, the service provider may enter into an agreement with a payment provider. The payment provider may pay the service provider for the service offered to the end user and bill the end user for that service. The network operator may also bill the service provider and the end user for access to a communications network.

### Network Environment

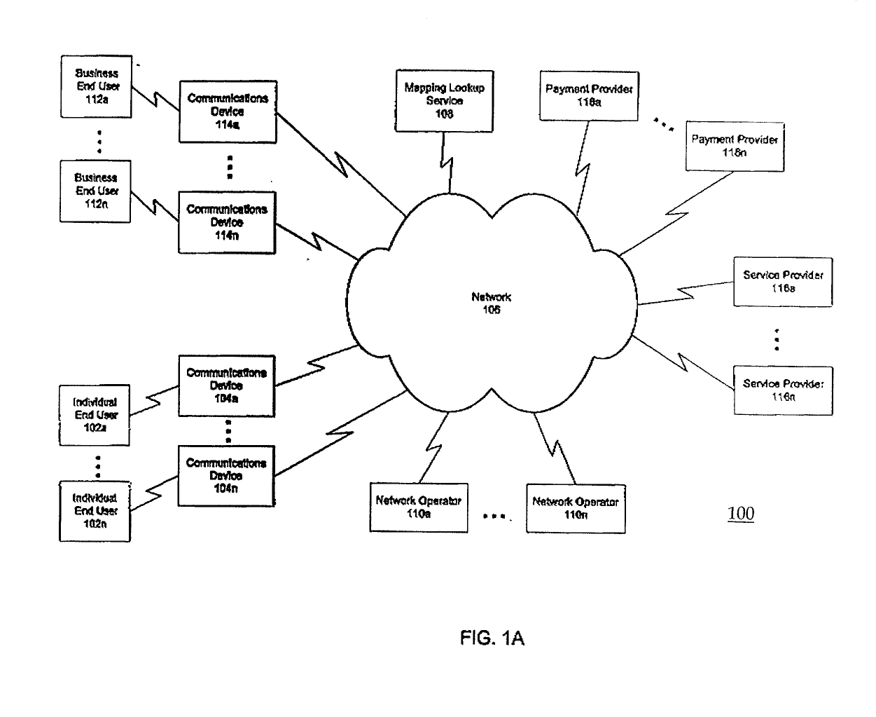

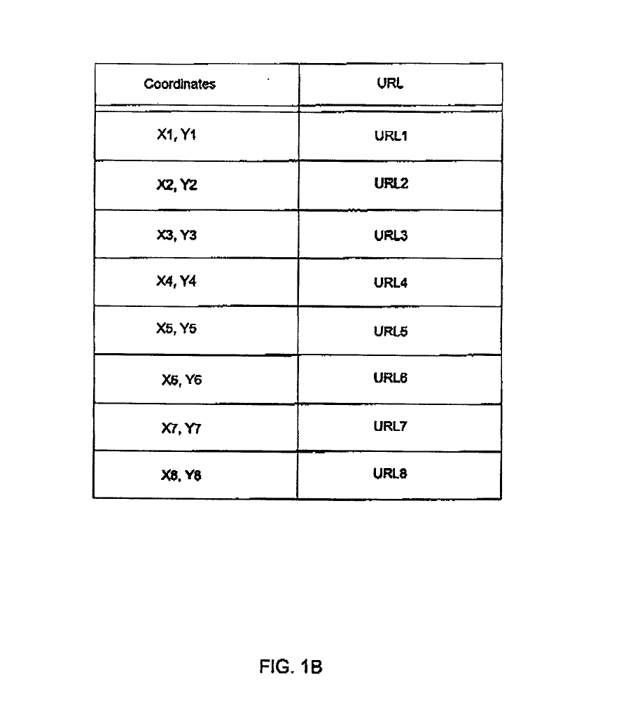

FIG. 1A is a diagram of an exemplary network environment in which the features and aspects of the present invention may be implemented. Network environment 100 may include individual end users 102a-102n, communications devices 104a-104n and 114a-114n, network 106, mapping lookup service 108, network operators 110a-110n, business end users 112a-112n, service providers 116a-116n, and payment providers 118a-118n. The number of components in network environment 100 is not limited to what is shown.

Individual end users 102a-102n may be individuals who use a portable hand-held device, such as a digital pen, and a surface, such as digital paper, to obtain services offered by a network operator or service provider. For example, writing from a digital pen on digital paper may be transformed to a facsimile message, an electronic mail (e-mail) message, or a short message (e.g., SMS—Short Message Service). The message may be routed to an appropriate destination, which may be indicated by the writing. The digital pen may include a transmitter for communicating directly over a network, or may include a transmitter for relaying information over a network through an intermediary communications device, such as a mobile telephone, or a network connected computer or PDA (Personal Digital Assistant). Another example of pen-related functions may include those that permit end users to purchase goods or services. For example, an advertisement for flowers may be printed with portions containing digital paper code. By touching an appropriate part of the advertisement with a digital pen, an order for flowers might be placed to a local flower shop, where the order can be fulfilled.

Business end users 112a-112n may use a portable hand-held device, such as a digital pen, and a surface, such as digital paper, in a manner similar to individual end users 102a-102n. Business end users, however, might typically use a digital pen in conjunction with an agreement between a network operator and a service provider. The business end user may either be an employee of or a business partner of the service provider in the arrangement. For example, a business end user 112a may be an employee of UPS (United Parcel Service). UPS might have a digital pen-based inventory system, and equip delivery personnel with digital pens for transmitting delivery status information to a host computer. Accordingly, UPS is a service provider (e.g., the new inventory service is the provided service). UPS may enter into an agreement with a network operator where a consolidated UPS account is billed, as opposed to billing separate accounts for each end user and pen.

Digital paper may be an ordinary piece of paper on which a unique proprietary pattern has been printed. A very small portion of the pattern may be associated with a uniquely defined function, such that when that pattern portion is detected by a digital pen, the associated function may be implemented. The pattern may include small dots with a nominal spacing, which are slightly displaced from a grid structure. As a customer writes on digital paper using a digital pen, the pen may take periodical snapshots of the pattern (e.g., every 1/100 second). Each snapshot may contain enough information to make a calculation of the exact position of the pen. This information can be stored in the pen and forwarded to an appropriate network operator or service provider after a mapping lookup service, such as mapping lookup service 108, determines what network operator or service provider corresponds to the particular location on the full pattern. Alternatively, the digital pen may be configured to read other forms of code, carrying information indicative of a function.

The complete addressable area covered by the full pattern may be divided into numerous domains varying in size, some of which are pre-defined for certain applications, while others are licensed to companies and authorities. For example, a network operator that provides a set of services to an end user, such as graphical e-mail and SMS, can license a domain. The area within a domain can be used for a range of applications, each with its own functionality assigned.

A digital pen may include, for example, a traditional ink container, a detector, such as a digital camera, an image processor, memory, and a transceiver. One of skill in the art will recognize that a digital pen may include either more or fewer components. For example, some digital pens may not include an ink container. The digital camera may take digital snapshots of the pattern, which may be illuminated by infrared light from the pen and visible to the camera. The image processor may calculate the exact position of the snapshots in the pattern. The position may be determined to the extent that coordinates corresponding to the snapshots can be determined. The memory may store the data from the image processor and may store several fully written pages.

The transceiver may transmit information by IR light or radio waves. The transceiver, which may be a Bluetooth transceiver, may transmit information via a communications device, such as communications device 104, to mapping lookup service 108. This information may include position information and a pen identification. The transceiver may also transmit data indicative of the writing on the digital paper to the appropriate network operator or service provider. While a digital pen has been described as including a Bluetooth transceiver, one of skill in the art will recognize that other transceivers can be used. The information transfer by the transceiver does not need to be wireless, but instead may be by cable.

An individual end user, such as individual end user 102a, may receive an invoice for services corresponding to the digital pen and digital paper from a variety of entities, such as a network operator, service provider, or payment provider. In response, the individual end user may send payment for the services to the appropriate entity. Sometimes, an individual end user may not get charged for services corresponding to the digital pen and digital paper but still be financially responsible to a network operator for the use of a communication channel provided by the network operator.

Communications devices 104a-104n and 114a-114n receive wireless information from a digital pen operated by an end user and forward it to remote locations, such as mapping lookup service 108, service providers 116a-116n, and/or network operators 110a-110n, via network 106 (which may comprise a wired or wireless communication network, including the Internet). This information may include a pen identification, position information, and handwritten data. A communication device, such as communication device 104a may also receive mapping information from mapping lookup service 108 for forwarding to a digital pen that requested the information. In one embodiment, mapping information may be a URL (uniform resource locator) of a network operator or service provider that is offering the service being utilized by the end user. A communication device may be, for example, a mobile telephone, a computer, or a PDA (personal digital assistant).

Mapping lookup service 108 may maintain a lookup table that associates position information with mapping information. Position information may include coordinates indicative of a location of a digital pen on digital paper. More particularly, the coordinates correspond to the location of the digital pen on the full pattern. This location may either be assigned a pre-defined application or licensed by a network operator or service provider. Mapping information may include a URL of a network operator or service provider that is offering the service being utilized by the end user (e.g., when the location is licensed).

FIG. 1B depicts a lookup table for use by mapping lookup service 108. The lookup table includes a list of coordinates and corresponding URLs. Mapping lookup service 108 may either store the lookup table locally or access it remotely. One of skill in the art will recognize that other information may be stored in a lookup table.

Mapping lookup service 108 receives requests from various end users looking for mapping information. After retrieving the appropriate mapping information, mapping lookup service may send the information to the requesting end user, who can then contact the appropriate network operator or service provider. As mapping lookup service 108 retrieves mapping information, it may collect billing data, noting the pen identification and the network operators or service providers that correspond to the relevant section of the pattern. Based on this billing data, mapping lookup service 108 may periodically send invoices to the various network operators and service providers for retrieving mapping information.

Network operators 110a-110n may be entities that provide end users and service providers with channels over which to communicate (e.g., communications services providers). For example, mobile operators or telecom operators, such as AT&T, Sprint, or MCI, may all be network operators. One of ordinary skill in the art will recognize that other organizations that make communications networks available to others may also be network operators.

In addition to providing communications channels (e.g., network access), a network operator, such as network operator 110a, may offer a variety of pen-related services to an end user. For example, network operator 110a may provide graphical e-mail, graphical fax, graphical SMS, digital note pad, or digital paper calendar services to individual end user 102a. The network operator may enter into business relationships with vendors to provide access to vendor information or to offer vendor goods or services. Other services may also be provided. If an individual end user 102a uses a pen-related service provided by network operator 110a, then network operator 110a may send an invoice to individual end user 102a for use of the service and/or for a cost of the goods/services obtained. This invoice may include an itemized list of services used by the end user or may be a lump sum bill. Alternatively, use of pen-related services may be part of an individual end user's overall communications service agreement with the network operator (e.g., no additional payment is necessary).

Service providers 116a-116n may be vendors or other entities that market and support pen-related services to end users. A service provider, such as service provider 116a, that offers a pen-related service for an individual end user or a business end user may be responsible to mapping lookup service 108 for the cost of any mapping information retrievals made for that service. Examples of service providers include UPS (as previously explained), an internet-based flower shop, or any other business that offers products and services to customers.

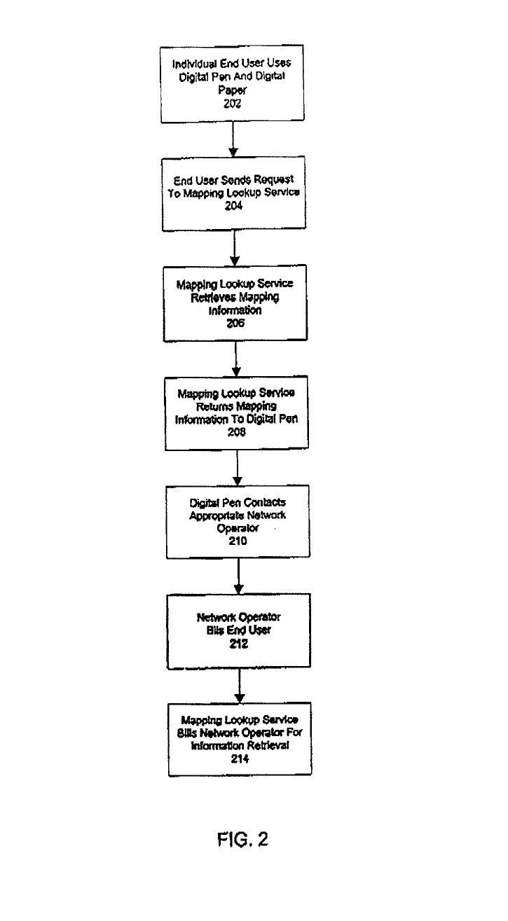

Service providers 116a-116n may enter into agreements with other entities, such as a network operator or payment provider. Each agreement may result in a different billing arrangement. A service provider typically may receive information from a digital pen indicative of a particular service desired by the end user with the pen. After giving the end user the desired service, the service provider may receive an invoice from mapping lookup service 108 for the mapping information retrieval. Depending on the billing arrangement, invoices and payments may also be exchanged in some manner between the service provider, a network operator, a payment provider, and the end user. Specific billing arrangements are more fully explained below with reference to FIGS. 2-5.

Payment providers 118a-118n may be financial institutions involved in agreements with various service providers and end users. A payment provider, such as payment provider 118a, may handle the billing of an end user for a service provider. While payment providers might not be involved in every transaction, they may add particular value when the service provider does not want to assume the financial risk of the transaction. The service provider may still receive an invoice from mapping lookup service 108 for mapping information retrieval and an invoice from a network operator for communications channel usage. In addition, the service provider may send an invoice to payment provider 118a and subsequently receives payment from payment provider 118a. Thus, the service provider may receive payments for services. These payments may be partly used to send payment to mapping lookup service 108. Examples of payment providers are credit card companies, utilities, or other organizations that have relationships with end users and/or service providers.

### Billing Arrangements

FIG. 2 is an exemplary flowchart of a method for a first billing arrangement in a manner consistent with the present invention. This billing arrangement might be particularly well suited to situations where a network operator wants to offer an end user a set of basic pen-related services that might be used more often than other pen-related services. In this arrangement, a network operator provides an individual end user with a service such as a pen-related service. First, the individual end user, such as individual end user 102a, uses a digital pen and digital paper to access a service offered by a network operator, such as network operator 110a (step 202). For example, individual end user 102a may desire to send a graphical e-mail to a specific person. Using digital pen and digital paper, individual end user 102a may write a handwritten message to the intended recipient. Upon completing the message, individual end user 102a may touch the digital pen to an area of the digital paper designated for sending messages. Recognizing the area of the digital paper as a send command, the digital pen may send a request to mapping lookup service 108 via communications device 104a (step 204). The request may include both a pen identification and position information. Position information may include, for example, coordinates in the full proprietary pattern.

Once mapping lookup service 108 has received the request, it may use the position information to lookup and retrieve mapping information that corresponds to the position information in a table (step 206). The mapping information, for example, may include a URL of a location dedicated to the transmission of graphical e-mail. After retrieving the mapping information, mapping lookup service 108 may return the mapping information to the digital pen of individual end user 102a using, for example, the pen identification information (step 208). The digital pen may use the mapping information (e.g., URL) to contact the appropriate network operator 110a, sending network operator 110a pen identification and position information (step 210). Once contact has been established, network operator 110a may instruct the digital pen on what data to send, how to format and tag that data, and where to send that data. The digital pen may then send network operator 110a the appropriate data, including the handwritten data that the digital pen stored when the end user wrote on the digital paper. Thereafter, network operator 110a may perform the particular pen-based service desired by individual end user 102a.

After performing the service, network operator 110a may bill individual end user 102a for use of the service (step 212). For example, network operator 110a may send individual end user 102a an invoice indicating that payment is due for the service. This invoice may include an itemized list of services used by the end user or may be a lump sum bill (invoices may be sent each time a service is provided, or a series of transactions may be batched together and billed to the user at one time). Alternatively, network operator 110a may send the invoice to an employer of individual end user 102a. Payments from individual end user 102a or the user's employer to network operator 110a may be, for example, transaction-based fees or flat rate fees. Alternatively, use of pen-related services may be part of an individual end user's overall communications service agreement with the network operator (e.g., no additional payment is necessary).

Mapping lookup service 108 may also bill network operator 110a for retrieval of the mapping information associated with network operator 110a (step 214). For example, mapping lookup service 108 may send network operator 110a an invoice indicating that payment is due for the information retrieval (e.g., mapping lookup service 108 seeks reimbursement for looking up the mapping information). Mapping lookup service 108 may send an invoice after each information retrieval, wait until a predetermined number of information retrievals have been made, or wait until a predetermined dollar amount has been reached. Also, a periodical invoice may be sent (e.g., weekly, monthly, etc.). Network operator 110a may make payments on invoices as required by predetermined arrangement.

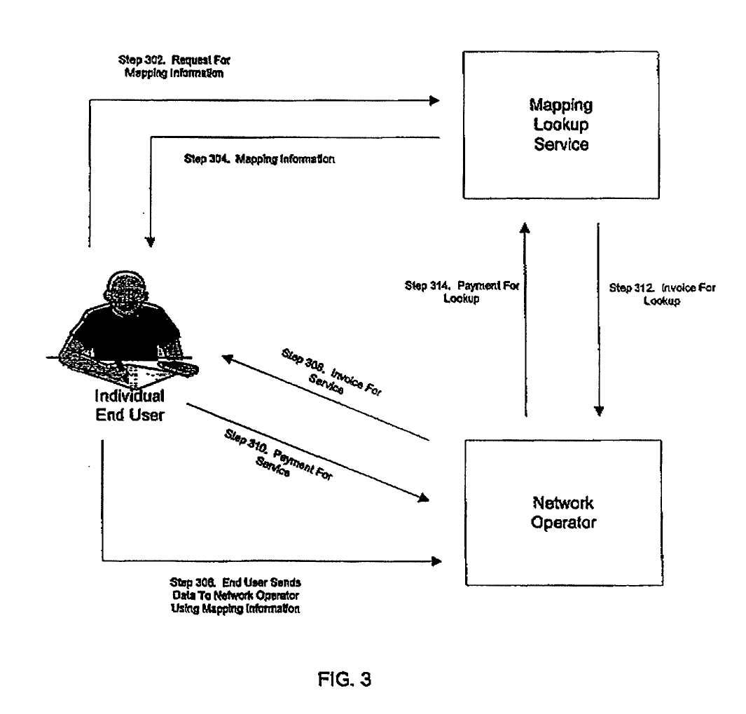

FIG. 3 is an exemplary diagram of an interaction between an individual end user, network operator, and mapping lookup service, when the billing arrangement described in FIG. 2 is used. The dataflow depicted in FIG. 3 corresponds to some of the steps in FIG. 2. Specifically, step 302 corresponds to step 204, step 304 corresponds to step 208, step 306 corresponds to step 210, steps 308 and 310 correspond to step 212, and steps 312 and 314 correspond to step 214.

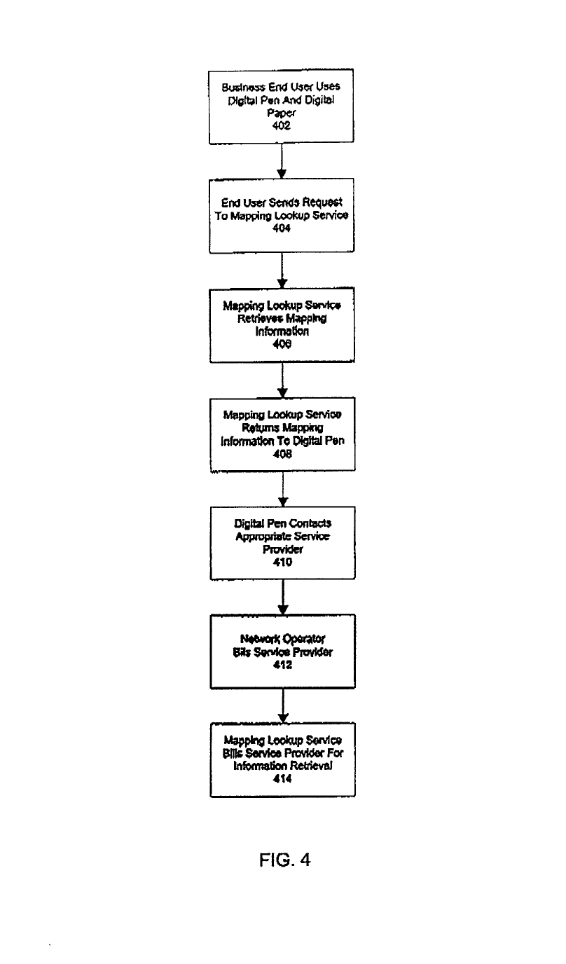

FIG. 4 is an exemplary flowchart of a method for a second billing arrangement in a manner consistent with the present invention. This billing arrangement might be particularly well suited to situations where a service provider may not desire to pass service costs on to its employees or business partners acting as end users. Instead, the service provider may prefer to have costs passed to itself as part of an agreement with a network operator. In this arrangement, a service provider provides a business end user with pen-related services. First, a business end user, such as business end user 112a, may make a request, such as through the use of a digital pen and digital paper for the purpose of utilizing a service offered by service provider 116a (step 402). For example, business end user 112a may be an employee or business partner of service provider 116a and desire to use a digital pen-based inventory service. Using a digital pen, business end user 112a may write on digital paper in an appropriate manner. Upon completion of the writing, business end user 112a may touch the digital pen to an area of the digital paper designated for sending information. Recognizing the area of the digital paper, the digital pen sends a request to mapping lookup service 108 via communications device 114a (step 404). The request may include a pen identification and position information (e.g., coordinates).

Once mapping lookup service 108 has received the request, it uses the position information to lookup and retrieve mapping information that corresponds to the position information in a table (step 406). The mapping information, for example, may include a URL of service provider 116a, who is providing the pen-related service to business end user 112a. After retrieving the mapping information, mapping lookup service 108 returns the mapping information to the digital pen of business end user 112a using, for example, the pen identification information (step 408). The digital pen may use the mapping information (e.g., URL) to contact the appropriate network operator 110a, sending network operator 110a pen identification and position information (step 410). Once contact has been established, network operator 110a may instruct the digital pen on what data to send, how to format and tag that data, and where to send that data. The digital pen may then send network operator 110a the appropriate data, including the handwritten data that the digital pen stored when the end user wrote on the digital paper. Thereafter, service provider 116a may perform the particular pen-based service desired by business end user 112a.

In this billing arrangement, business end user 112a may either be an employee of or a business partner of service provider 116a. Accordingly, service provider 116a may not desire to pass service costs on to business end user 112a. Instead, service provider 116a may enter into an agreement with a network operator where the business end users do not get charged for using the communications channels or other services of the network operator. These costs may instead be passed to service provider 116a as part of the agreement. Thus, the network operator may bill service provider 116a per the agreement (step 412). To accomplish this, network operator 110a may send service provider 116a an invoice indicating that payment is due for use of the communication channel that network operator 110a provided. Service provider 116a may then remit to the network operator 110a an appropriate payment.

Mapping lookup service 108 may also bill service provider 116a for retrieval of the mapping information associated with service provider 116a (step 414). For example, mapping lookup service 108 may send service provider 116a an invoice indicating that payment is due for the information retrieval. Mapping lookup service 108 may send an invoice after each information retrieval, wait until a predetermined number of information retrievals have been made, or wait until a predetermined dollar amount has been reached. Also, a periodical invoice may be sent (e.g., weekly, monthly, etc.). Service provider 116a may then remit appropriate payments.

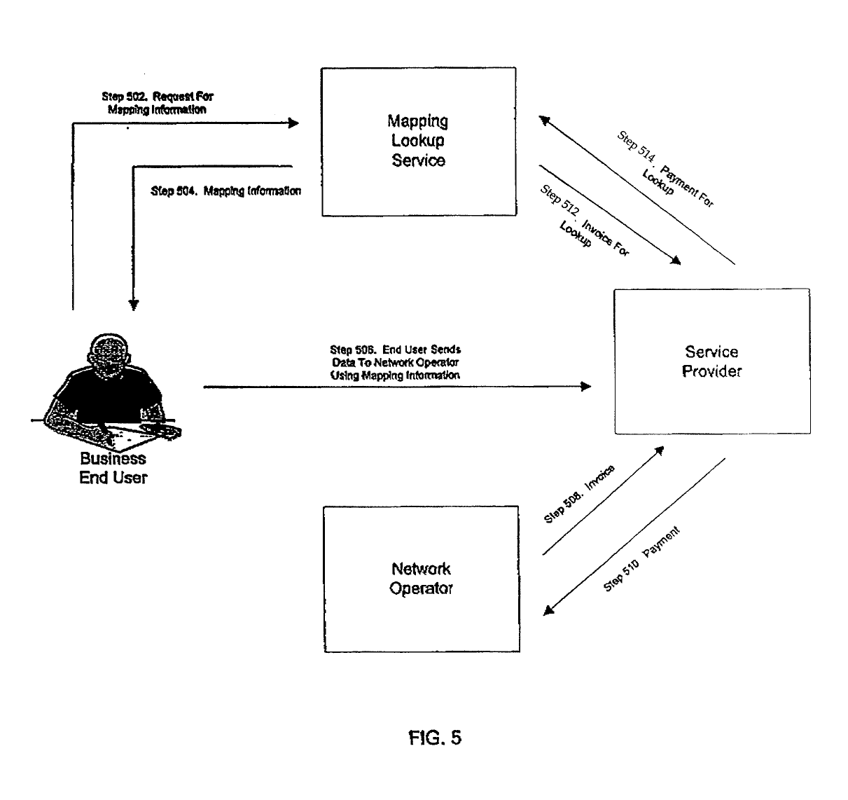

FIG. 5 is an exemplary diagram of an interaction between a business end user, network operator, service provider, and mapping lookup service, when the billing arrangement described in FIG. 4 is used. The dataflow depicted in FIG. 5 corresponds to some of the steps in FIG. 4. Specifically, step 502 corresponds to step 404, step 504 corresponds to step 408, step 506 corresponds to step 410, steps 508 and 510 correspond to step 412, and steps 512 and 514 correspond to step 414.

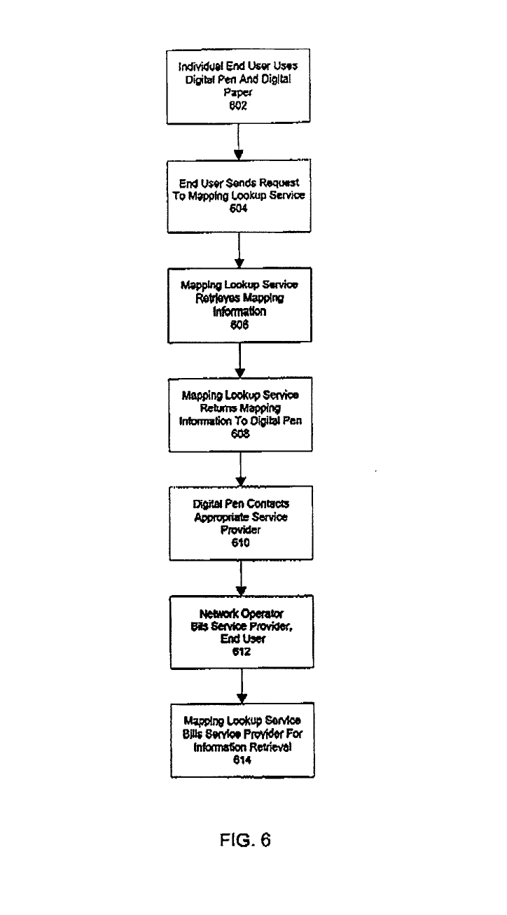

FIG. 6 is an exemplary flowchart of a method for a third billing arrangement in a manner consistent with the present invention. This billing arrangement might be particularly well suited to situations where a service provider may want to offer a pen-related service to an individual end user. In this arrangement, a service provider may provide an individual end user with pen-related services. First, an individual end user, such as individual end user 102a, may use a digital pen and digital paper for the purpose of accessing a service offered by a service provider, such as service provider 116a (step 602). For example, an individual end user 102a desiring to order flowers may do so by scanning with a digital pen a coded portion of an advertisement for flowers. As a result, an order for flowers may be placed to a local flower shop, where the order can be fulfilled and charged to the user's phone bill, for example. Recipient information may be inputted and transmitted using the digital pen, and the identity of the purchaser may be known by a unique identification number transmitted by the pen.

Another example is an individual end user purchasing plane tickets using a coded airline advertisement. In order for a service to be completed, individual end user 102a may first need to touch the digital pen to an area of the digital paper designated for sending messages. Recognizing the area of the digital paper, the digital pen may send a request to mapping lookup service 108 (step 604). The request may include a pen identification and position information (e.g., coordinates).

Once mapping lookup service 108 receives the request, it may use the position information to lookup and retrieve mapping information that corresponds to the position information in a table (step 606). The mapping information, for example, may include a URL of service provider 116a, who is providing the pen-related service to individual end user 102a. After retrieving the mapping information, mapping lookup service 108 may return the mapping information to the digital pen of individual end user 102a using, for example, the pen identification information (step 608). The digital pen may use the mapping information (e.g., URL) to contact the appropriate network operator 110a, sending network operator 110a pen identification and position information (step 610). Once contact has been established, network operator 110a may instruct the digital pen on what data to send, how to format and tag that data, and where to send that data. The digital pen may then send network operator 110a the appropriate data, including the handwritten data that the digital pen stored when the end user wrote on the digital paper. Thereafter, service provider 116a may perform the particular pen-based service desired by individual end user 102a.

A network operator, such as network operator 110a may bill both individual end user 102a and service provider 116a for using the communications channels of the network operator (e.g., providing network access) (step 612). For example, network operator 110a may send individual end user 102a and service provider 116a invoices indicating that payment is due for carrying data over its communications channels.

Service provider 116a may choose to bill individual end user 102a for the service performed. For example, as previously mentioned, an individual end user 102a who purchased flowers using digital pen and digital paper may receive an invoice for the flowers directly from service provider 116a. Alternatively, individual end user 102a may receive an invoice for the flowers from network operator 110a as a part of the invoice normally received from network operator 110a. In that case, network operator 110a may reimburse service provider 116a for the purchased product/service (e.g., flowers).

Mapping lookup service 108 may also bill service provider 116a for retrieval of the mapping information associated with service provider 116a (step 214). For example, mapping lookup service 108 may send service provider 116a an invoice indicating that payment is due for the information retrieval. Mapping lookup service 108 may send an invoice after each information retrieval, wait until a predetermined number of information retrievals have been made, or wait until a predetermined dollar amount has been reached. Also, a periodical invoice may be sent (e.g., weekly, monthly, etc.). Service provider 116a may then remit appropriate payments.

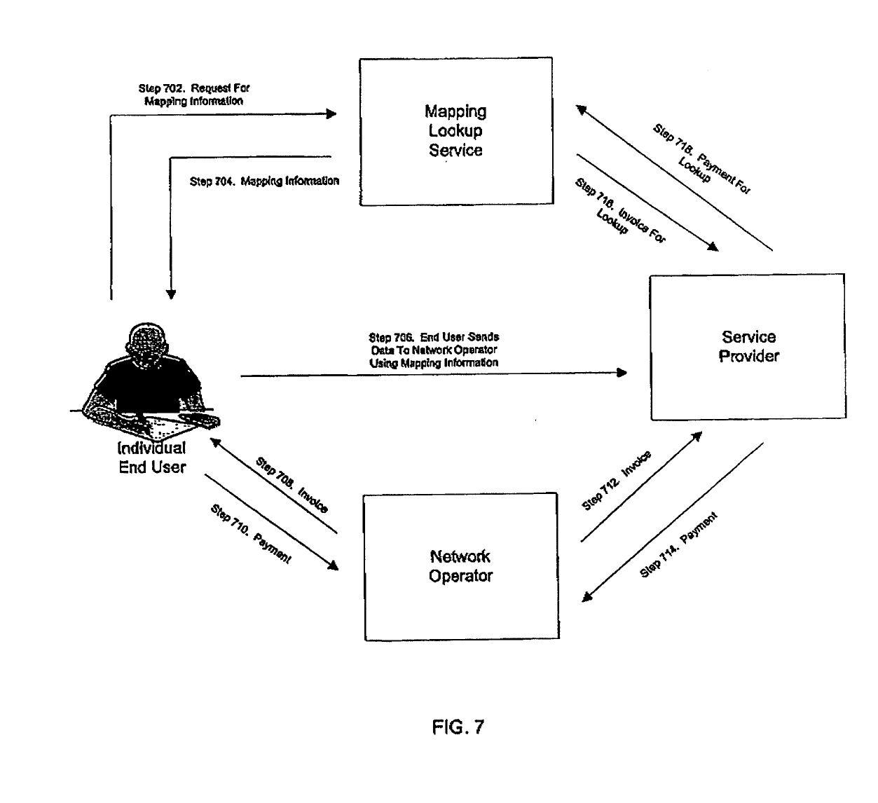

FIG. 7 is an exemplary diagram of the interaction between a business end user, network operator, service provider, and mapping lookup service, when the billing arrangement described in FIG. 6 is used. The dataflow depicted in FIG. 7 corresponds to some of the steps in FIG. 6. Specifically, step 702 corresponds to step 604, step 704 corresponds to step 608, step 706 corresponds to step 610, steps 708, 710, 712, and 714 correspond to step 612, and steps 716 and 718 correspond to step 614.

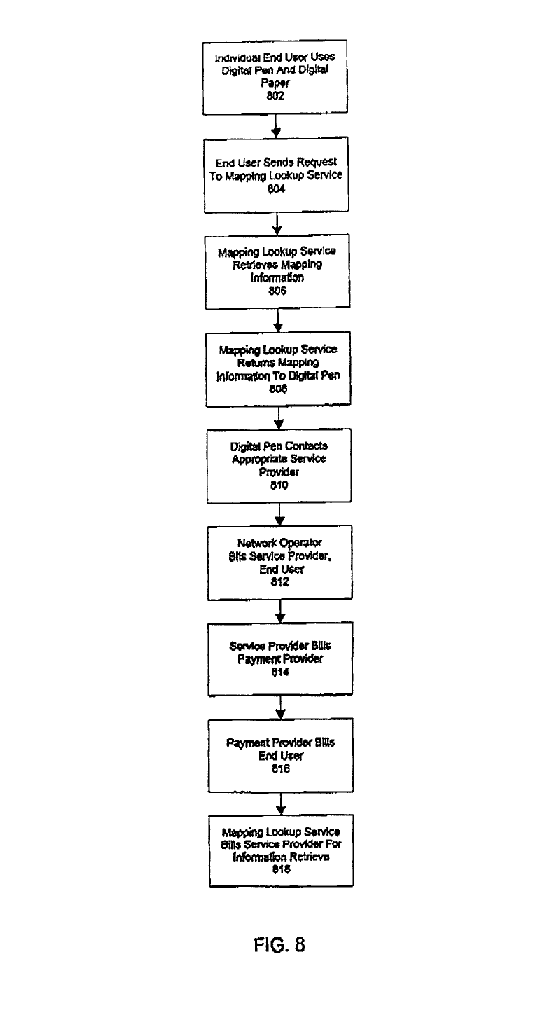

FIG. 8 is an exemplary flowchart of a method for a fourth billing arrangement in a manner consistent with the present invention. This billing arrangement might be particularly well suited to situations where the service provider does not want to assume the financial risk of the transaction and would prefer to use the service of, for example, a third party financial institution. In this arrangement, a service provider or network operator may provide an individual end user with pen-related services. First, an individual end user, such as individual end user 102a, may use a digital pen and digital paper for the purpose of accessing a service offered by a network operator or a service provider, such as service provider 116a (step 802). For example, an individual end user 102a desiring to order furniture may do so by using an advertisement for furniture with parts of the advertisement printed on digital paper. By scanning appropriate portions of the advertisement with a digital pen, an order for furniture can be placed to a furniture shop, where the order can be fulfilled. In order for a service to be completed, individual end user 102a may first need to touch the digital pen to various areas of the digital paper to select options such as fabric choice. The user may then scan an area designated for sending messages. Recognizing the area of the digital paper, the digital pen may send a request to mapping lookup service 108 via communications device 104a (step 804). The request may include a pen identification and position information (e.g., coordinates).

Once mapping lookup service 108 receives the request, it may use the position information to lookup and retrieve mapping information corresponding to the position information in a table (step 806). The mapping information, for example, may include a URL of service provider 116a, who is providing the pen-related service to individual end user 102a. After retrieving the mapping information, mapping lookup service 108 may return the mapping information to the digital pen of individual end user 102a using, for example, the pen identification information (step 808). The digital pen may use the mapping information (e.g., URL) to contact the appropriate network operator 110a, sending network operator 110a pen identification and position information (step 810). Once contact has been established, network operator 110a may instruct the digital pen on what data to send, how to format and tag that data, and where to send that data. The digital pen may then send network operator 110a the appropriate data, including the handwritten data that the digital pen stored when the end user wrote on the digital paper. Thereafter, service provider 116a may perform the particular pen-based service desired by individual end user 102a.

A network operator, such as network operator 110a may bill both individual end user 102a and service provider 116a for using the communications channels of the network operator (step 812). For example, network operator 110a may send individual end user 102a and service provider 116a invoices indicating that payment is due for carrying data over its communications channels.

Since furniture is a relatively costly acquisition, the service provider or network operator may not want to assume the risk of collecting payment on a periodical bill (e.g., monthly phone bill). Thus, a payment provider, such as payment provider 118a, might handle the billing of an end user for a service provider. Accordingly, payment provider 118a essentially assumes the financial risk of collecting payments. Service provider 116a may send an invoice to payment provider 118a and subsequently receives payment from payment provider 118a (step 814). Thus, the service provider may immediately receive reimbursement. In turn, payment provider 118a may send an invoice to individual end user 102a for the services provided by or through the service provider 116a (step 816). One of skill in the art will recognize that a network operator could provide the end user the pen-related service. In that case, the network operator may perform the processing described above with reference to service providers 116a.

Mapping lookup service 108 may also bill service provider 116a for retrieval of the mapping information associated with service provider 116a (step 818). For example, mapping lookup service 108 may send service provider 116a an invoice indicating that payment is due for the information retrieval. Mapping lookup service 108 may send an invoice after each information retrieval, wait until a predetermined number of information retrievals have been made, or wait until a predetermined dollar amount has been reached. Also, a periodical invoice may be sent (e.g., weekly, monthly, etc.). Service provider 116a may then remit payment appropriately.

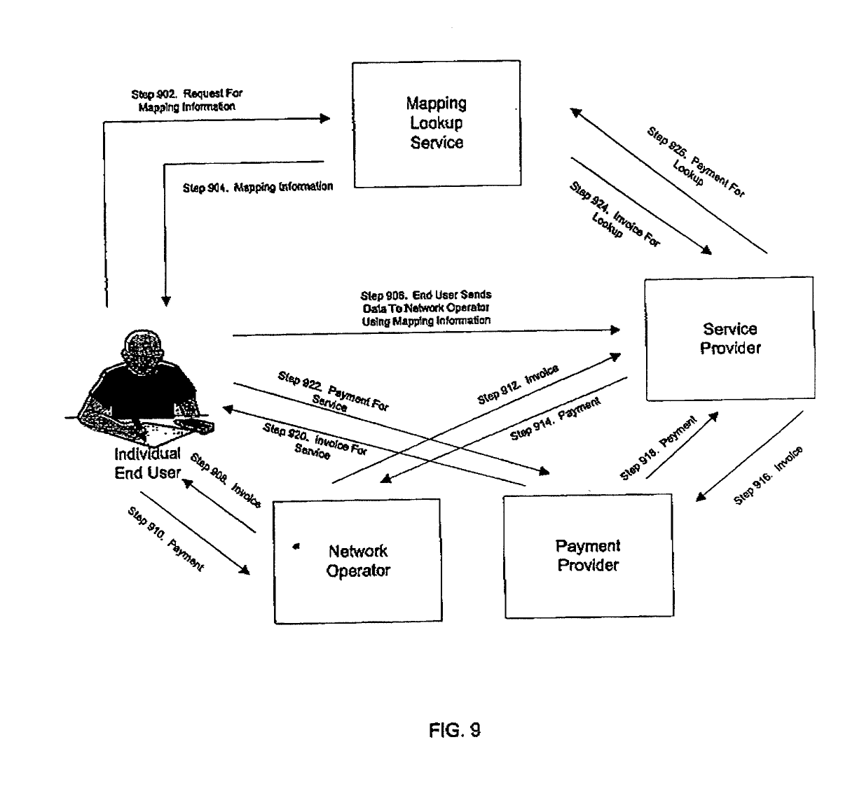

FIG. 9 is an exemplary diagram of the interaction between a business end user, network operator, service provider, payment provider, and mapping lookup service, when the billing arrangement described in FIG. 8 is used. The dataflow depicted in FIG. 9 corresponds to some of the steps in FIG. 8. Specifically, step 902 corresponds to step 804, step 904 corresponds to step 808, step 906 corresponds to step 810, steps 908, 910, 912, and 914 correspond to step 812, steps 916 and 918 correspond to step 814, steps 920 and 922 correspond to step 816, and steps 924 and 926 correspond to step 818.

Co-pending with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30,2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

While the present invention has been described in connection with various embodiments, many modifications will be readily apparent to those skilled in the art. For example, while the billing arrangements in FIGS. 2-9 have been described separately, one skilled in the art will appreciate that some or all of these arrangements can exist concurrently. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. In addition, while the steps of the various flow charts and diagrams are presented in particular orders, one skilled in the art will appreciate that the steps may be performed in different orders, some steps may be omitted, and some steps added—all within the spirit and scope of the invention.

Further, while the description employs an exemplary embodiment of a mapping lookup service, the invention in its broadest sense is not so limited. The code detected by the pen need not be part of a larger map, but may instead contain a more directly executable instruction. The invention, therefore is not limited to the disclosure herein, but is intended to cover any adaptations or variations thereof.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A method for collecting payments in a communications system, the method comprising:
receiving a request, via a provider of communications services, to provide a product to a user, the request being generated in response to the user detecting information using a pen-like device that generates a signal reflective of the request;
causing information to be transmitted in response to the received request; and
transmitting a request for payment to the provider of communications services.

2. The method of claim 1 wherein the product includes an information look-up provided by a look-up service, and wherein the request for payment seeks reimbursement for a look-up fee by the look-up service.

3. The method of claim 2 wherein the request for payment includes a single request for reimbursement for multiple information look-ups.

4. The method of claim 2 further comprising billing the user for the information lookup, wherein the user is billed by the communications services provider.

5. The method of claim 2, wherein the communications services provider batches a series of information look-ups initiated by the user and bills the user at one time for the series of look-ups.

6. The method of claim 2, wherein the communications services provider batches a series of information look-ups and bills an employer of the user for information look-ups initiated by a plurality of user employees of the employer.

7. The method of claim 1, wherein during causing, the information is transmitted from a look-up service to the user's pen-like device.

8. The method of claim 1, wherein the product is chosen from the group consisting of goods and services.

9. The method of claim 8, wherein the request includes an order to purchase the product from a vendor, and wherein the provider of communications services reimburses the vendor for a purchase by the user.

10. The method of claim 8, wherein the provider of communications services bills the user for the user's purchase from the vendor.

11. The method of claim 8, wherein the provider of communications services bills the user for the user's purchase from the vendor in a single billing statement which also invoices communications services.

12. The method of claim 1 wherein the product includes both an information look-up provided by a look-up service and at least one item chosen from the group consisting of goods and services, and wherein during transmitting, a look-up service transmits to the communications services provider a request for reimbursement of a look-up fee, and a vendor of the item transmits to the communications services provider a request for reimbursement for the item.

13. A method for collecting payments in an communications system, the method comprising:
receiving a request at a look-up service to provide an information look-up to a user, the request being generated in response to the user detecting information using a pen-like device that generates a signal reflective of the request;
causing information to be transmitted from the look-up service to the user; and
billing an entity other than the user, a fee for the information look-up.

14. The method of claim 13, wherein the entity other than the user is a communications services provider who provides a communication link between the user and the look-up service.

15. The method of claim 14, wherein the communications services provider bills the user for the information look-up.

16. The method of claim 13, wherein during billing the look-up service sends a request for reimbursement to an organization with whom the user is affiliated.

17. The method of claim 16, wherein the organization is an employer of the user.

18. The method of claim 16, wherein during billing, the look-up service bundles a series of payment requests for individual information look-ups, and transmits the bundle directly to the organization in a single request for reimbursement.

19. A method for collecting payments in a communications system, comprising:
receiving a request for mapping information corresponding to a position of a digital pen on digital paper, the position corresponding to a service offered by a network operator;
retrieving the mapping information;
sending the mapping information to the digital pen; and
collecting a payment from the network operator for retrieving the mapping information.

20. The method of claim 19, wherein the received request includes both an identification for the digital pen and coordinates indicative of the position of the digital pen on the digital paper.

21. The method of claim 19, wherein the mapping information includes a uniform resource locator (URL) of the network operator.

22. The method of claim 19, said collecting comprising:
billing the network operator for retrieving the mapping information; and
receiving the payment from the network operator.

23. The method of claim 22, wherein the payment from the network operator is a portion of a payment the network operator received from an end user.

24. A method for collecting payments in a communications system, comprising:
receiving a request for mapping information corresponding to a position of a digital pen on digital paper, the position corresponding to a service offered by a network operator;
retrieving the mapping information;
sending the network operator an invoice for the retrieving; and
collecting a payment from the network operator for the invoice.

25. A method for collecting payments in a communications system, comprising:
billing an end user for a service initiated by moving a digital pen on digital paper;
receiving a payment from the end user for the service;
receiving an invoice from a mapping lookup service for retrieving mapping information corresponding to the position of the digital pen on the digital paper; and
sending the mapping lookup service a portion of the payment received from the end user.

26. The method of claim 25, wherein the mapping information includes a uniform resource locator (URL) of a network operator offering the service that corresponds to the position of the digital pen.

27. A method for collecting payments in a communications system, comprising:
receiving a request for mapping information corresponding to a position of a digital pen on digital paper, the position corresponding to a service offered by a service provider;
retrieving the mapping information;
sending the mapping information to the digital pen; and collecting payment from the service provider for the retrieving.

28. The method of claim 27, wherein the service provider sends payment to a network operator for access to a communications network.

29. The method of claim 27, wherein the service provider bills a payment provider for the service offered by the service provider, and the payment provider bills an end user for the service.

30. The method of claim 29, wherein the end user sends payment to the network operator for access to the communications network.

31. The method of claim 27, wherein the request includes both an identification for the digital pen and coordinates indicative of the position of the digital pen on the digital paper.

32. The method of claim 27, wherein the mapping information includes a uniform resource locator (URL) of the service provider.

33. The method of claim 27, said collecting comprising:
billing the service provider for retrieving the mapping information; and
receiving the payment from the service provider.

34. A method for collecting payments in a communications system, comprising:
providing a service for an end user that corresponds to a position of a digital pen on digital paper;
receiving an invoice from a mapping lookup service for retrieving mapping information corresponding to the position of the digital pen on the digital paper; and
sending the mapping lookup service payment for the invoice.

35. The method of claim 34, further comprising;
receiving an invoice from a network operator for access to a communications network; and
sending payment to the network operator for the invoice from the network operator.

36. The method of claim 35, wherein the end user sends payment to the network operator for access to the communications network.

37. The method of claim 34, wherein the mapping information includes a uniform resource locator (URL) of the service provider.

38. A system for collecting payments in a communications system, comprising:
a mapping lookup service operable to retrieve mapping information corresponding to a position of a digital pen on digital paper in response to a request for the mapping information; and
a network operator operable to offer a service corresponding to the position of the digital pen and bill an end user for the service corresponding to the position of the digital pen, wherein the mapping lookup service collects payment from the network operator for retrieving the mapping information.

39. The system of claim 38, wherein the mapping information includes a uniform resource locator (URL) of the network operator.

40. A system for collecting payments in a communications system, comprising:
a mapping lookup service operable to retrieve mapping information corresponding to a position of a digital pen on digital paper in response to a request for the mapping information;
a service provider operable to offer a service corresponding to the position of the digital pen to an end user, wherein the mapping lookup service collects payment from the service provider for retrieving the mapping information; and
a network operator operable to bill the service provider for access to a communications network.

41. The system of claim 40, wherein the mapping information includes a uniform resource locator (URL) of the service provider.

42. The system of claim 40, wherein the network operator bills the end user for access to the communications network.

43. A system for collecting payments in a communications system, comprising:
a mapping lookup service operable to retrieve mapping information corresponding to a position of a digital pen on digital paper in response to a request for the mapping information;
a service provider operable to offer a service corresponding to the position of the digital pen to an end user, wherein the mapping lookup service collects payment from the service provider for retrieving the mapping information;
a payment provider operable to bill the end user for the service corresponding to the position of the digital pen, wherein the service provider bills the payment provider for the service corresponding to the position of the digital pen.
a network operator operable to bill the service provider and the end user for access to a communications network.

44. The system of claim 43, wherein the mapping information includes a uniform resource locator (URL) of the service provider.
